(19) United States
(12) Patent Application Publication
(10) Pub. No.: US 2005/0084805 A1
(43) Pub. Date: Apr. 21, 2005

(54) Method for forming patterned ITO structure by using photosensitive ITO solution

(76) Inventors: Lu-Yi Yang, Taipei City (TW); Ching-Chung Cheng, Tao-Yuan (TW); Yen-Ting Shen, Taipei City (TW); Yuan-Chi Lin, Tao-Yuan City (TW)

Correspondence Address: LOWE HAUPTMAN GILMAN & BERNER, LLP;Suite 310, 1700 Diagonal Road, Alexandria, VA, 22314, US

(21) Appl. No.: 10/687,612

(22) Filed: Oct. 20, 2003

(51) Int. Cl. G03C 5/00

(52) U.S. Cl. 430/311

(57) ABSTRACT

A method for forming a patterned ITO structure by using a photosensitive ITO solution is provided. By mixing both the ITO and photosensitive material to form a photosensitive ITO solution on a substrate, a patterned ITO structure is available by directly exposing and developing the photosensitive ITO layer. Significantly, no photo-resist layer is required.

### BACKGROUND OF THE INVENTION

1. Field of the Invention

The invention relates to a method for forming a patterned ITO structure and more particularly to a method without using the photo-resist layer during the process of transferring pattern to construct patterned ITO structure.

2. Description of the Prior Art

ITO (indium-tin oxide) in the past has usually been applied on products that are equipped with transparent conductive wires or lines, such as the TFT-LCD and plasma display. As an example, we have been using ITO as the material for the conductive wire connecting the pixels of the display. In the prior art, as shown in U.S. Pat. No. 5,702,871, the basic steps of forming a patterned ITO structure are as follows:

FIG. 1A is a schematic diagram illustrating the sputtering ITO layer 11 on a substrate layer 10. Furthermore, a semiconductor structure (such as transistor) is formed on the substrate.

FIG. 1B is a schematic diagram illustrating the formation of the photosensitive layer 12 (such as photo-resist and sensitively dry layer) on the ITO layer 11 and at least the photosensitive layer 12 must cover those portions of layer 11 where it will be patterned.

FIG. 1C is a schematic diagram illustrating the transferring patterns from the mask 13 to the photosensitive layer 12 under these steps including exposure, lithograph and etch processes.

FIG. 1D is a schematic diagram illustrating the transferring patterns from the photosensitive layer 12 to the ITO layer 11 and then the layer 12 is removed after patterning the ITO layer 11.

Although the process for constructing the patterned ITO structure has been improved in the prior art as shown in U.S. Pat. No. 6,448,158 and U.S. Pat. No. 6,451,391, the prior art on patterning the ITO layer usually has to use the photosensitive layer 12 and most of them only modify the details, such as material and parameters of the process.

However, for the development of LCD manufacturing, the subject of reducing the steps in constructing the patterned ITO layer is significantly related with reducing cost. Because the method in the prior art must individually pattern both the photosensitive layer and the ITO layer, that is, transferring patterns from mask to ITO layer through patterned photosensitive layer. Therefore, reducing the steps of constructing the patterned ITO layer will be a major object to be achieved.

### SUMMARY OF THE INVENTION

The methods and the systems of the present invention address many shortcomings of the prior art. One of the objects in the present invention is to provide a method without using the photosensitive layer in the process of constructing the patterned ITO layer.

Another object in the present invention is to provide a process that reduces the costs in manufacture.

The essential characteristics of the invention are as follows:

(1) Generating the photosensitive ITO solution by directly mixing both the ITO and photosensitive materials. It means combining both the ITO and Photosensitive layers to be one photosensitive ITO layer.

(2) Directly exposing and developing on photosensitive ITO layer. It means directly transferring patterns from the mask to the photosensitive ITO layer without breaking through the photosensitive layer.

(3) The method without using photo-resist and other photosensitive layer can reduce the treatment of the photosensitive layer.

(4) Reducing those steps of sputtering ITO on the substrate, which are presented in the prior art. According to the invention, coating the photosensitive ITO solution on the substrate is easy.

Further comparing with the prior art, the excellence of the present invention are shown as follows:

(1) Generating the photosensitive ITO solution by directly mixing both the ITO and photosensitive material. It means that both the ITO and photosensitive layers are integrated to one photosensitive ITO layer. So it has no need to form two separate photosensitive and ITO layers in the present invention and therefore simplify the process.

(2) Directly coating the photosensitive ITO solution on the substrate instead of the complicated steps of the prior art, sputtering ITO on the substrate. The steps for generating and coating the photosensitive ITO solution are simpler than the steps of a sputtering ITO, including gasifying and bombarding the ITO. So the present method of the invention could also reduce the cost in manufacturing.

(3) Directly exposing and developing the photosensitive ITO layer, that is, directly transferring the patterns from mask to the photosensitive ITO layer without breaking through the photosensitive layer. Although the present method in the invention also uses a mask to define the pattern's location on the photosensitive ITO layer, the process of patterning ITO layer has been effectively simplified by using the present method.

(4) Reducing the treatment of the photo-resist without using any photosensitive layers in the invention. So the method of the present invention has no need to remove the unused photosensitive layer after the step of patterning ITO layer.

Significantly, the present method in the invention can simplify the process and reduce the cost of constructing the patterned ITO structure.

### BRIEF DESCRIPTION OF DRAWINGS

The foregoing aspects and many of the attendant advantages of this invention will become more readily appreciated as the same becomes better understood by reference to the following detailed description, when taken in conjunction with the accompanying drawings, wherein:

FIGS. 1A to 1D are schematic diagrams illustrating those steps of patterning ITO layer of the prior art;

FIGS. 2A to 2C are schematic diagrams illustrating essential steps of the present method in the invention for patterning photosensitive ITO layer; and

FIGS. 3A to 3D are schematic diagrams illustrating several examples of the method presented in the invention for constructing patterned ITO structure.

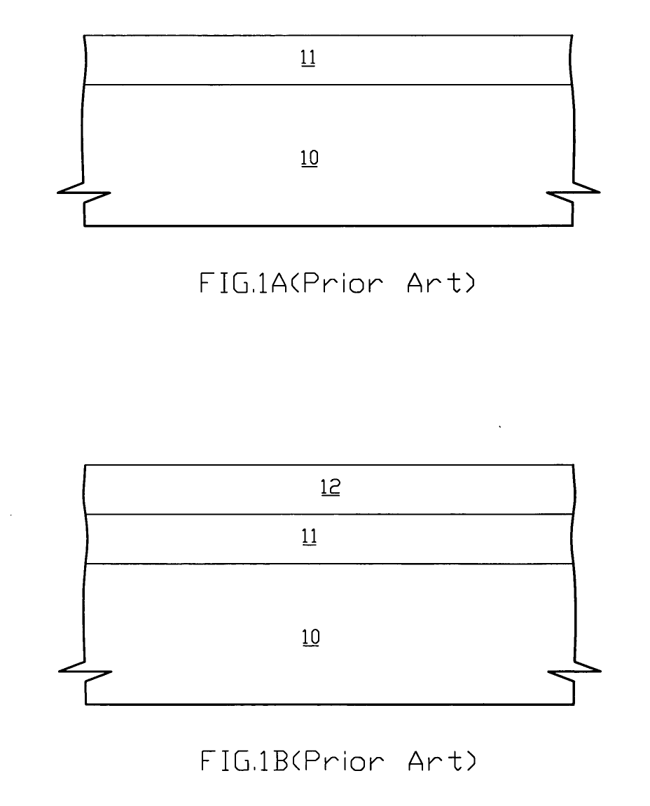

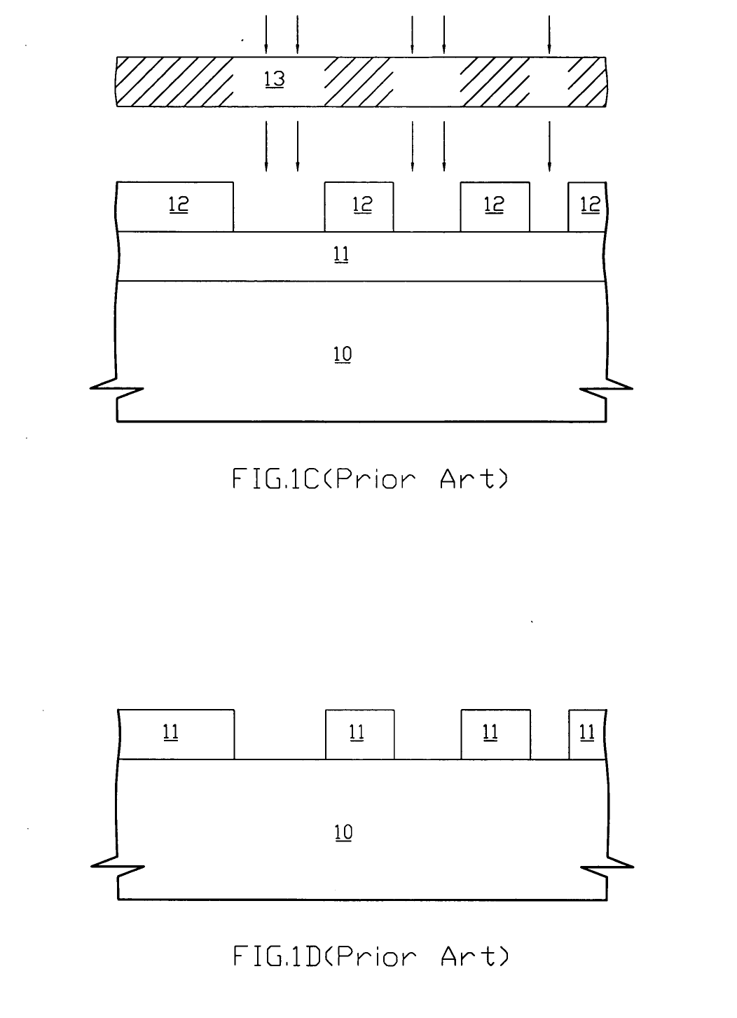

### DESCRIPTION OF THE INVENTION

An appropriate and preferred embodiment will now be described in the form of a patterned ITO structure. It should be noted, however, that this embodiment is merely an example and can be variously modified without departing from the scope of the present invention. The present invention provides a performance method described as follows:

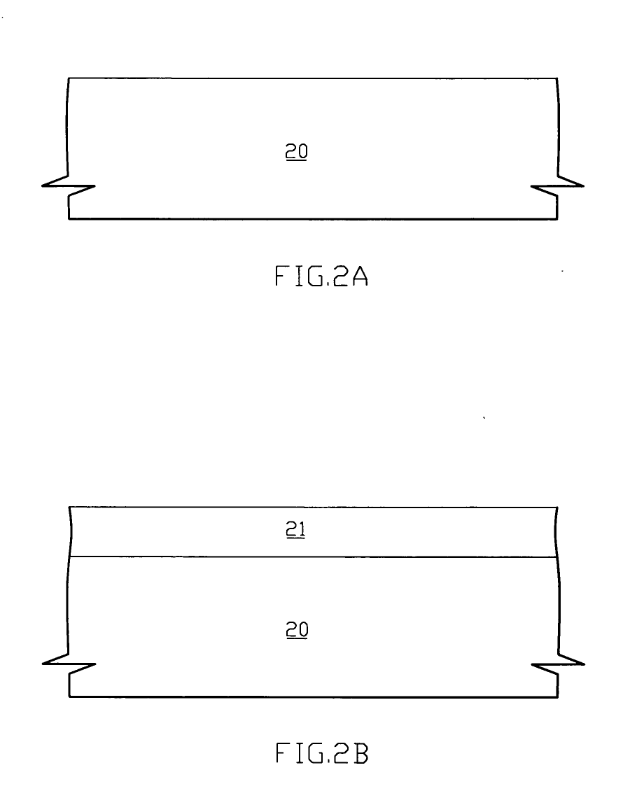

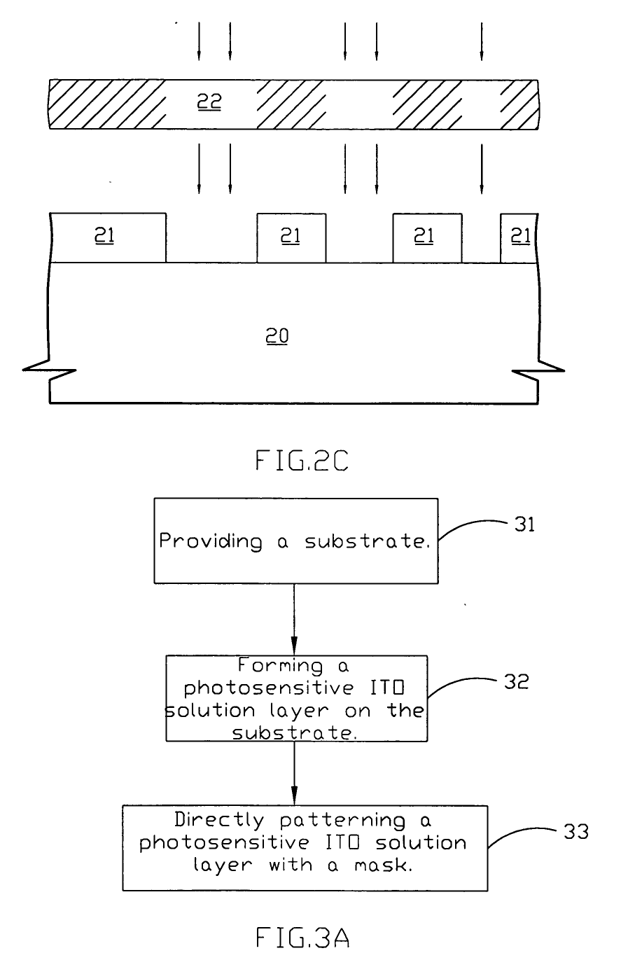

FIGS. 2A to 2C are schematically cross-sectional diagrams illustrating the steps of the fabricating method in accordance with the present invention. As shown in FIG. 2A, a substrate 20, such as a transparent or translucent substrate, is provided. Next, a photosensitive layer, such as a photosensitive ITO solution layer 21, is formed on the substrate 20, as shown in FIG. 2B. Depicted as FIG. 2C, the photosensitive ITO solution layer 21 is directly patterned with a mask 22 as a patterning mask.

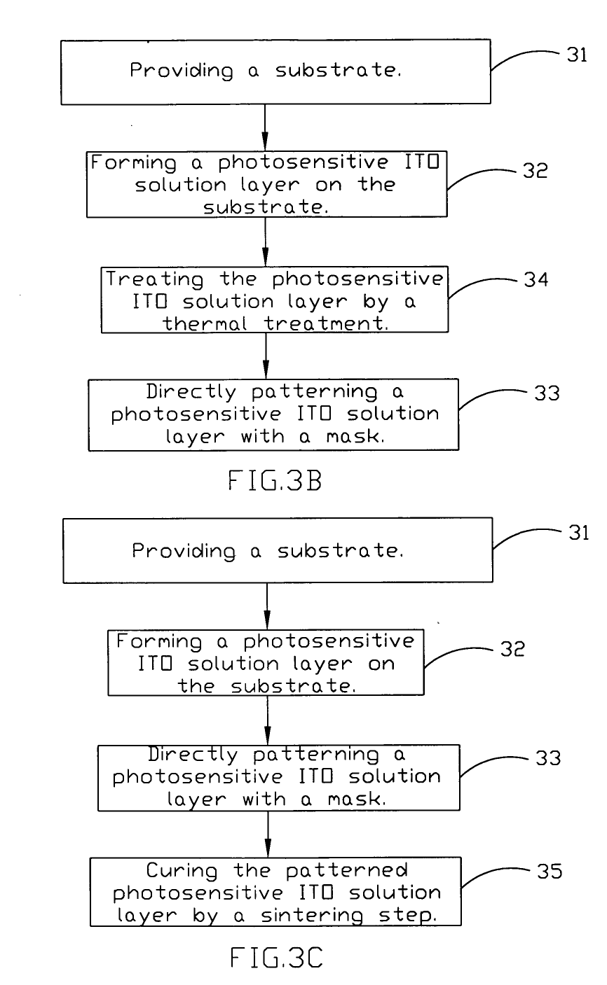

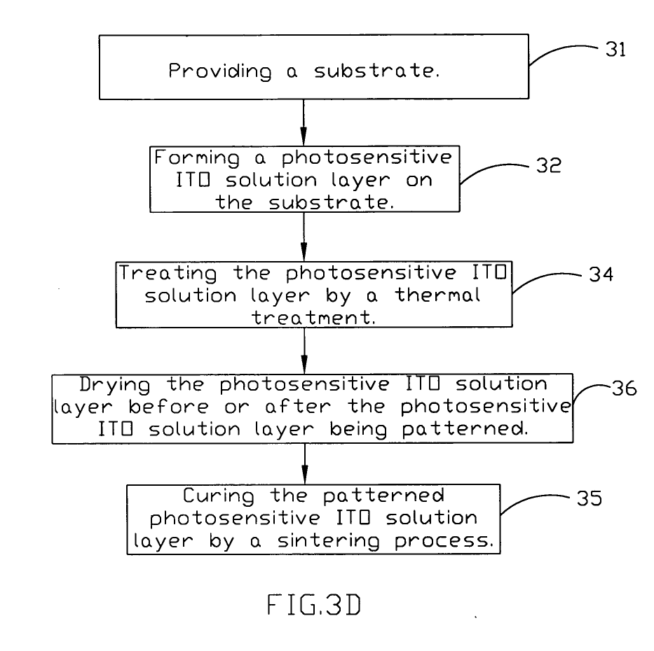

FIG. 3A is a schematic flow chart illustrating the steps of one embodiment in accordance with the present invention. First, a substrate is provided (step 31). Next, a photosensitive ITO solution layer is formed on the substrate (step 32), and then the photosensitive ITO solution layer is directly patterned with a mask (step 33).

FIG. 3B is another schematic flow chart illustrating the steps of another embodiment in accordance with the present invention. Similarly, the photosensitive ITO solution layer is first formed on the substrate, as well as the steps 31 and 32 as shown in FIG. 3A. Next, the photosensitive ITO solution layer is implemented by a thermal treatment (step 34) so as to cure the photosensitive ITO solution layer.

FIG. 3C is another schematic flow chart illustrating the steps of another embodiment in accordance with the present invention. Similarly, the photosensitive ITO solution layer is directly patterned on the substrate, as well as the steps 31, 32 and 33 as shown in FIG. 3A. Next, the patterned photosensitive ITO solution layer is further cured by a sintering step (step 35) if necessary. Furthermore, the sintering step is configured for removing the portion of composition, such as an adhesive agent, resin, and photo-resist.

FIG. 3D is another schematic flow chart illustrating the steps of another embodiment in accordance with the present invention. Similarly, the photosensitive ITO solution layer is formed on the substrate and is implemented by the thermal treatment, as well as the steps 31, 32, and 34 as shown in FIG. 3B. Next, a drying process is implemented before or after the patterning of the photosensitive ITO solution layer (step 36). After the patterning of the photosensitive ITO solution layer, the patterned photosensitive ITO solution layer is further cured by the sintering step (step 35).

Of course, it is noted that, the thermal treatment (step 34) and the sintering step (step 35) are independent of each other. The method presented in the invention can use one of them, all of them or none. Further, the sintering step (step 35) and the drying process (step 36) are not absolutely necessary. That is according with the method presented in this invention, step 31, step 32 and step 33 are requisite and the others are optional if needed.

In the present invention, on the substrate 20, photosensitive ITO solution layer 21 is formed by any suitable coating method, such as slit coating, table coating, cap coating, spin coating, spray coating, or screen-print coating. Furthermore, the photosensitive ITO solution is prepared by well mixing both of soluble ITO powder and dispersedly photosensitive material, such as photo-resist. In order to make the solutions fulfill distribution uniform with enough mobility in powder, some additives, such as adhesive agent, dispersion and resin, would be added into the photosensitive ITO solution.

In the invention, the process of forming a photosensitive ITO layer 21 usually has these essential steps, which includes:

(a) exposing a pattern on the photosensitive ITO solution layer 21 through a provided mask; and

(b) developing the exposed photosensitive ITO solution layer 21. One of features of the present invention is that there is only the photosensitive ITO solution layer 21, exclusive of use of any other additive photo-resist layer. The photosensitive ITO solution layer 21, exposed by the patterning mask, is directly patterned by illumination of light. In one embodiment of the present invention, a light source could be ultraviolet rays, deep-ultraviolet rays, x-ray or yellow light. And a developer could be water, an alkaline solution or an organic solution.

As a sample, at this moment when coating the photosensitive ITO layer 21 on the substrate 20, the weight-percent of ITO is about 20˜30 percent and the thickness is about 2˜3 micrometers. Further, on the thermal treatment process, the temperature reaches at 100˜150 degrees Centigrade and lasts for about 20˜30 minutes. Besides, on the sintering step, the temperature reaches at 500˜600 degrees Centigrade and lasts for about 10˜30 minutes, and the thickness of the photosensitive ITO layer 21 is about one micrometer. Also, on the drying process, the temperature reaches at 100˜150 degrees Centigrade and lasts for about 10˜20 minutes.

Furthermore, the wavelength of the light source in the exposure process is about 300˜500 micrometers. The exposure process lasts for about 30˜90 seconds. The water can be used as a developer with a developing time about 20˜50 seconds.

Naturally, the present method in the invention needs a heating process, such as a thermal treatment process, sintering step and drying process, which can be done by an oven. And it is without any difficulty in the prior art. Especially during the period of heating, no significant damage will be caused on the transistors and the pixels, which are loaded on the substrate caused of the temperature is low and the required time is short.

While this invention has been described with reference to the illustrative embodiments, the description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method for forming patterned ITO structure by using photosensitive ITO solution, comprising:
providing a substrate;
forming a photosensitive ITO layer on said substrate; and
patterning said photosensitive ITO layer.

2. The method according to claim 1, wherein said patterning step is performed without covering an additional photoresist layer on the photosensitive ITO layer.

3. The method according to claim 1, wherein said photosensitive ITO layer has about 20-30 percentage of ITO in weight.

4. The method according to claim 1, wherein said photosensitive ITO layer is about 2-3 micrometers in thickness.

5. The method according to claim 1, wherein said photosensitive ITO layer is formed on the substrate by coating.

6. The method according to claim 5, wherein said photosensitive ITO layer is coated by slit coating, table coating, cap coating, spin coating, spraying coating, or screen-print coating.

7. The method according to claim 1, wherein said patterning step comprises:
exposing said photosensitive ITO layer by a light source through a mask; and
developing the exposed photosensitive ITO layer.

8. The method according to claim 7, wherein said light source is ultraviolet rays, deep-ultraviolet rays, x rays, or yellow light.

9. The method according to claim 7, wherein said photosensitive ITO layer is developed by water, alkaline solution, or organic solution.

10. The method according to claim 1, before the patterning step, further comprising thermally treating said photosensitive ITO layer.

11. The method according to claim 10, wherein said thermally treating step is performed at about 100 degrees Centigrade.

12. The method according to claim 10, wherein said thermally treating step lasts about 10-20 minutes.

13. The method according to claim 1, after the patterning step, further comprising sintering said photosensitive ITO layer.

14. The method according to claim 13, wherein said sintering step is configured for curing said patterned photosensitive ITO layer.

15. The method according to claim 13, wherein said sintering step is configured for further removing a portion of said photosensitive ITO layer including an adhesive agent, resin, and photoresist.

16. The method according to claim 13, wherein said sintering step is performed at about 500-600 degrees Centigrade.

17. The method according to claim 13, wherein said sintering step lasts about 10-30 minutes.

18. The method according to claim 13, wherein said patterned photosensitive ITO layer remains about 1 micrometer in thickness after the sintering step.

19. The method according to claim 13, before or after the patterning step, further comprising drying said photosensitive ITO layer.

20. The method according to claim 19, wherein said drying step is performed at about 100-150 degrees Centigrade, and lasts about 10-20 minutes.
